(19) United States
(12) Patent Application Publication
(10) Pub. No.: US 2020/0210179 A1
(43) Pub. Date: Jul. 2, 2020

(54) UNIFORMITY CHECK BASED INSTRUCTIONS

(71) Applicant: Intel Corporation, Santa Clara, CA (US)

(72) Inventor: Elmoustapha Ould-Ahmed-Vall, Chandler, AZ (US)

(21) Appl. No.: 16/235,908

(22) Filed: Dec. 28, 2018

(51) Int. Cl. G06F 9/30

(52) U.S. Cl. CPC G06F 9/3016; G06F 9/30029; G06F 9/30036; G06F 9/30014

(57) ABSTRACT

Novel instructions, their format, and support thereof are described. For example, an instruction having an opcode to indicate that execution circuitry is to: perform a packed data operation as indicated by the opcode as a scalar and broadcast operation when there is uniformity between packed data elements in identified source operands by performing a single scalar operation using scalar circuitry that is equivalent to the packed data operation using one packed data element of each of the identified source operands to generate a single result and broadcast the single result into each packed data element positions of the identified packed data destination operand.

Single Instruction, Multiple Data (SIMD) architectures can be implemented in microprocessor systems to enable one instruction to operate on several operands in parallel. SIMD architectures take advantage of packing multiple data elements within one register or contiguous memory location. With parallel hardware execution, multiple operations are performed on separate data elements by one instruction to increase a performance of the microprocessor systems.

### BRIEF DESCRIPTION OF DRAWINGS

Various embodiments in accordance with the present disclosure will be described with reference to the drawings, in which:

FIG. 1 illustrates an exemplary execution of an instruction to perform a logical or arithmetic operation.

FIG. 2 illustrates an exemplary execution of an instruction to perform a logical or arithmetic operation where there is no uniformity.

FIG. 3 illustrates an exemplary execution of an instruction to perform a gather operation.

FIG. 4 illustrates an exemplary execution of an instruction to perform a gather operation.

FIG. 5 illustrates an exemplary execution of an instruction to perform a scatter operation.

FIG. 6 illustrates an exemplary execution of an instruction to perform a scatter operation.

FIG. 7 illustrates an embodiment of hardware to process an instruction such as the uniformity-based instructions detailed herein.

FIG. 8 illustrates an embodiment of method performed by a processor to process a uniformity-based logical or arithmetic instruction.

FIG. 9 illustrates an embodiment of method performed by a processor to process a uniformity-based gather instruction.

FIG. 10 illustrates an embodiment of method performed by a processor to process a uniformity-based scatter instruction.

FIG. 11A is a block diagram illustrating an exemplary instruction format according to embodiments of the invention;

FIG. 11B is a block diagram illustrating the fields of the instruction format that make up the full opcode field according to one embodiment of the invention;

FIG. 11C is a block diagram illustrating the fields of the instruction format that make up the register index field according to one embodiment of the invention;

FIG. 11D is a block diagram illustrating the fields of the instruction format that make up the augmentation operation field according to one embodiment of the invention;

FIG. 12 is a block diagram of a register architecture according to one embodiment of the invention;

FIG. 13A is a block diagram illustrating both an exemplary in-order pipeline and an exemplary register renaming, out-of-order issue/execution pipeline according to embodiments of the invention;

FIG. 13B is a block diagram illustrating both an exemplary embodiment of an in-order architecture core and an exemplary register renaming, out-of-order issue/execution architecture core to be included in a processor according to embodiments of the invention;

FIGS. 14A-B illustrate a block diagram of a more specific exemplary in-order core architecture, which core would be one of several logic blocks (including other cores of the same type and/or different types) in a chip;

FIG. 15 is a block diagram of a processor that may have more than one core, may have an integrated memory controller, and may have integrated graphics according to embodiments of the invention;

FIG. 16 shown a block diagram of a system in accordance with one embodiment of the present invention;

FIG. 17 is a block diagram of a first more specific exemplary system in accordance with an embodiment of the present invention;

FIG. 18 is a block diagram of a second more specific exemplary system in accordance with an embodiment of the present invention;

FIG. 19 is a block diagram of a SoC in accordance with an embodiment of the present invention; and

FIG. 20 is a block diagram contrasting the use of a software instruction converter to convert binary instructions in a source instruction set to binary instructions in a target instruction set according to embodiments of the invention.

### DETAILED DESCRIPTION

Various embodiments of methods, apparatus, systems, and non-transitory computer-readable storage media for instructions using a uniformity check are described. In particular, a uniformity check between data elements of a packed data operand (such as a single instruction, multiple data (SIMD) or vector register or memory location) is performed. The result of that uniformity check impacts how an operation of the instruction as indicated by the instruction's opcode is to be performed.

Typically performing, for example, a vector arithmetic or logical operation on two or more packed data source operands causes the arithmetic or logical operation to be performed with respect to each position of the packed data source operands independently. For example, an independent addition of data elements stored in the corresponding packed data element positions of source vector registers would be performed for a vector add. Unfortunately, there are times when the data elements have the same value and these independent additions are wasteful from at least an energy standpoint. Similarly, gathers and scatters of data elements may involve the gathering or scattering of the same value which may again be wasteful from at least an energy standpoint

Embodiments detailed herein include instructions and their hardware support that utilize at least one uniformity check of data elements of one or more sources of the instruction to determine how to approach the operation (such as a logical, arithmetic, gather, and/or scatter operation). For example, when all of the data elements of each source of a vector addition instruction are the same (as in all of the data elements of a first source are the same and all of the data elements of a second source are the same, but not necessarily the same as the data elements of the first source) only one add operation is performed and the result is broadcast to the destination. As such, the energy usage should be less than performing independent additions operations. Further, in some embodiments, the addition operation is not performed by vector/SIMD hardware, but by scalar hardware. Note such instructions and support are improvements to a computer itself.

### EXEMPLARY EXECUTIONS

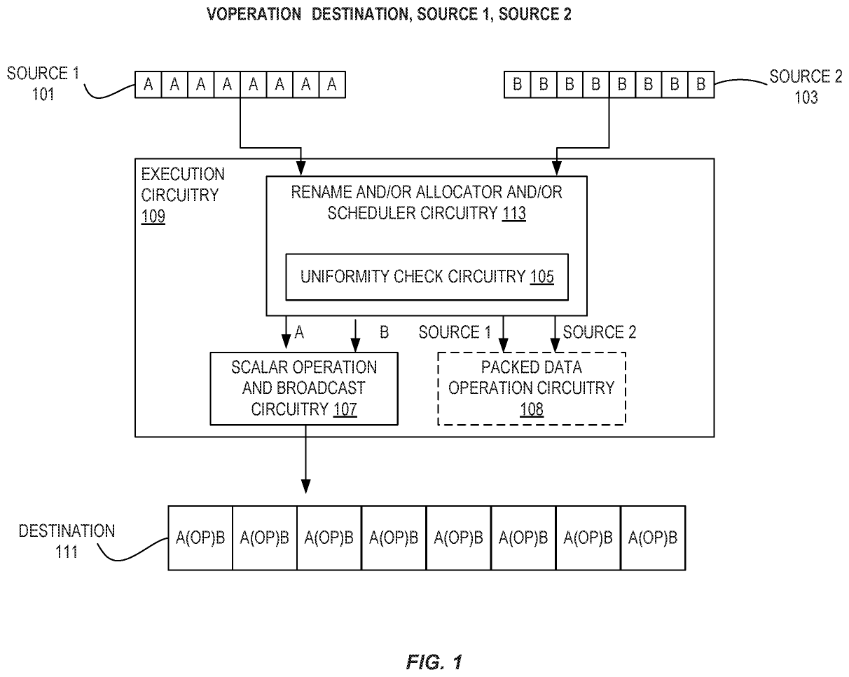

FIG. 1 illustrates an exemplary execution of an instruction to perform a logical or arithmetic operation. The instruction format includes fields for a vector opcode (VOPERATION) that defines the logical or arithmetic operation to perform (e.g., VPADD, etc.), a field to identify a destination operand, a field to identify a first source operand, and a field to identify a second source operand. In some embodiments, the destination and one of the source operands are the same. Further, in some embodiments, the field for one of the source operands is a plurality of fields to be used to determine a memory (non-register) address. In some embodiments, the opcode defines a packed data (vector or SIMD) operation that is to be performed.

In this illustrated example, the identified first source 101 has 8 packed data elements (i.e., 8 vector elements or 8 SIMD elements) which all store the same value of “A”. The identified second source 103 has 8 packed data elements (i.e., 8 vector elements or 8 SIMD elements) which all store the same value of “B”.

There are several ways to determine if elements of the two sources 101 and 103 are respectively uniform. In some embodiments, a compiler will assume that they are the same. In other embodiments, uniformity check circuitry 105 within the processor will make this determination. As shown, one or more of register rename circuitry, allocation circuitry, and/or scheduler circuitry 113 is used to make this determination. While these circuits are shown as being a part of execution circuitry 109 it should be understood that one or more of these circuits could be a part of a front end of a processor or processor core. In some embodiments, the uniformity check circuitry 105 includes a plurality of logical ANDs to be used to test elements against each other.

Execution circuitry 109 includes both scalar operation and broadcast circuitry 107 and packed data operation circuitry 108. The scalar operation and broadcast circuitry 107 is utilized when there is uniformity within each of the identified source operands 101 and 103 and performs a scalar operation consistent with the vector operation dictated by the instruction's opcode and the result of that scalar operation is broadcast to all of the data element positions of the identified destination operand 111. The packed data operation circuitry 108 is utilized when there is not uniformity within each of the identified source operands 101 and 103 to perform the vector operation dictated by the instruction's opcode by performing individual operations using data elements from corresponding data element positions of the identified source operands 101 and 103 with each result being stored in a corresponding data element position of the identified destination operand 111.

In this example, the scalar operation and broadcast circuitry 107 is utilized as there is uniformity in each of the identified source operands 101 and 103.

In some embodiments, the opcode is an existing opcode to perform a vector logical or arithmetic operation. In other embodiments, the opcode is a different opcode than an existing opcode to perform a vector logical or arithmetic operation and this different opcode indicates that the uniformity check should always occur.

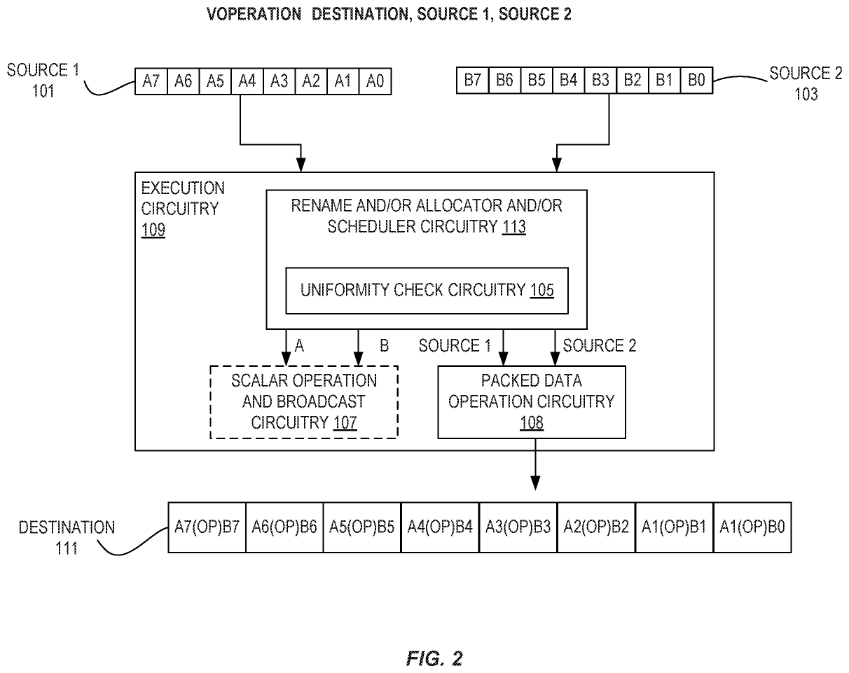

FIG. 2 illustrates an exemplary execution of an instruction to perform a logical or arithmetic operation where there is no uniformity. The instruction format includes fields for a vector opcode (VOPERATION) that defines the logical or arithmetic operation to perform, a field to identify a destination operand, a field to identify a first source operand, and a field to identify a second source operand. In some embodiments, the destination and one of the source operands are the same. Further, in some embodiments, the field for one of the source operands is a plurality of fields to be used to determine a memory (non-register) address. In some embodiments, the opcode defines a packed data (vector or SIMD) operation that is to be performed.

In this illustrated example, the identified first source 101 has 8 packed data elements (i.e., 8 vector elements or 8 SIMD elements) which all do not store the same value. The identified second source 103 has 8 packed data elements (i.e., 8 vector elements or 8 SIMD elements) which all do not store the same value.

There are several ways to determine if elements of the two sources 101 and 103 are respectively uniform. In some embodiments, a compiler will assume that they are the same. In other embodiments, uniformity check circuitry 105 within the processor will make this determination. As shown, one or more of register rename circuitry, allocation circuitry, and/or scheduler circuitry 113 is used to make this determination. While these circuits are shown as being a part of execution circuitry 109 it should be understood that one or more of these circuits could be a part of a front end of a processor or processor core. In some embodiments, the uniformity check circuitry 105 includes a plurality of logical ANDs to be used to test elements against each other.

Execution circuitry 109 includes both scalar operation and broadcast circuitry 107 and packed data operation circuitry 108. The scalar operation and broadcast circuitry 107 is utilized when there is uniformity within each of the identified source operands 101 and 103 and performs a scalar operation consistent with the vector operation dictated by the instruction's opcode and the result of that scalar operation is broadcast to all of the data element positions of the identified destination operand 111. The packed data operation circuitry 108 is utilized when there is not uniformity within each of the identified source operands 101 and 103 to perform the vector operation dictated by the instruction's opcode by performing individual operations using data elements from corresponding data element positions of the identified source operands 101 and 103 with each result being stored in a corresponding data element position of the identified destination operand 111.

In this example, the packed data operation circuitry 108 is utilized as there is not uniformity in at least one of the identified source operands 101 and 103.

In some embodiments, the opcode is an existing opcode to perform a vector logical or arithmetic operation. In other embodiments, the opcode is a different opcode than an existing opcode to perform a vector logical or arithmetic operation and this different opcode indicates that the uniformity check should always occur.

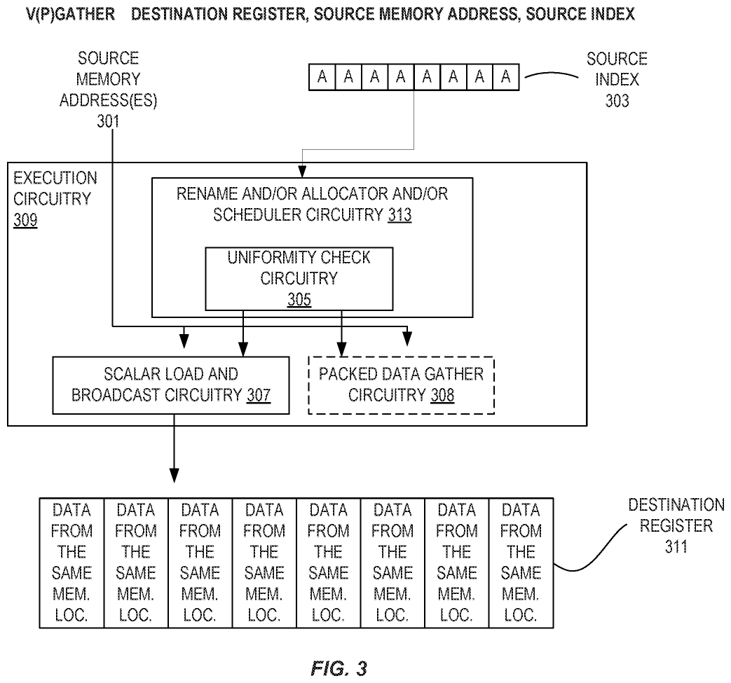

FIG. 3 illustrates an exemplary execution of an instruction to perform a gather operation. The instruction format includes fields for an opcode (V(P)GATHER) that defines the vector gather operation to perform, a field to identify a destination operand, a field to identify a first source operand, and a field to identify a second source operand. In some embodiments, one of the identified first or second source operands is a packed data register which stores a plurality of indices and in total is a source index. Further, in some embodiments, the field for one of the source operands is a plurality of fields to be used to determine a memory (non-register) address.

In this illustrated example, the identified source index 303 has 8 packed data elements (i.e., 8 vector elements or 8 SIMD elements) which all store the same value of “A”. The identified source memory address(es) 301 reference(s) at least a starting point for gathering data elements from memory. In some embodiments, each element of the source index 303 is used as an index value in a scale-index-base (SIB) type addressing scheme used to generate the source memory address(es) 301.

There are several ways to determine if elements of the identified source index 303 are uniform. In some embodiments, a compiler will assume that they are the same. In other embodiments, uniformity check circuitry 305 within the processor will make this determination. One or more of register rename circuitry, allocation circuitry, and/or scheduler circuitry 313 is used to make this determination similar to detailed above. While these circuits are shown as being a part of execution circuitry 309 it should be understood that one or more of these circuits could be a part of a front end of a processor or processor core. In some embodiments, the uniformity check circuitry 305 includes a plurality of logical ANDs to be used to test elements against each other.

Execution circuitry 309 includes both scalar load operation and broadcast circuitry 307 and packed data gather circuitry 308. The scalar load operation and broadcast circuitry 307 is utilized when there is uniformity within the identified source index 303 and performs a scalar load operation consistent with the vector gather operation dictated by the instruction's opcode and the result of that scalar load operation is broadcast to all of the data element positions of the identified destination operand 311. The packed data gather circuitry 308 is utilized when there is not uniformity within the identified source index operand 303 to perform the vector gather operation dictated by the instruction's opcode by performing individual memory retrievals of data elements at source memory addresses 301 generated using the identified source index 303 and storing each of the retrieved data elements in a corresponding data element position of the identified destination operand 311.

In this example, the scalar load operation and broadcast circuitry 307 is utilized as there is uniformity in the identified source index operand 303.

In some embodiments, the opcode is an existing opcode to perform a vector gather operation. In other embodiments, the opcode is a different opcode than an existing opcode to perform a vector gather operation and this different opcode indicates that the uniformity check should always occur.

Note too that this illustration is for a simple case wherein only uniformity is considered. As will be detailed later, the uniformity check circuitry 305 may also look for consecutive values in the indices and/or for an indication of clustering in the indices.

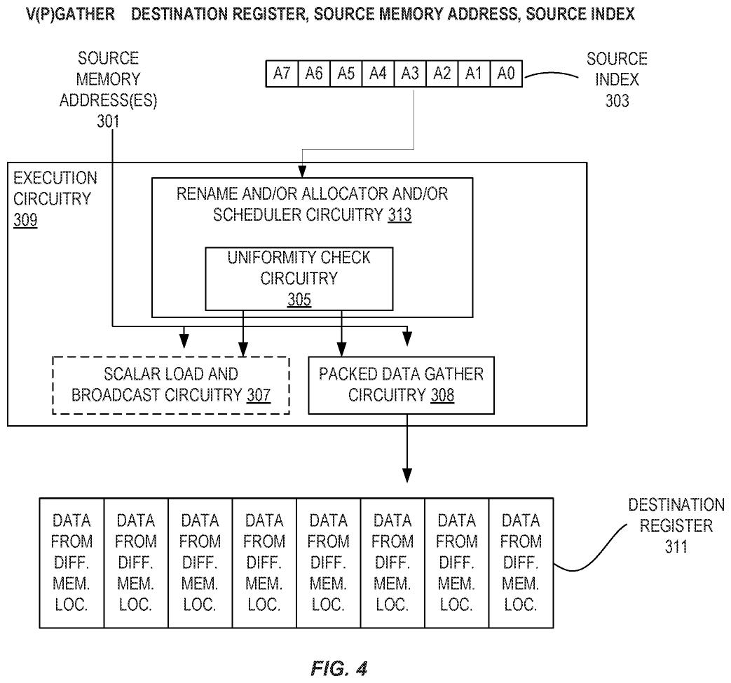

FIG. 4 illustrates an exemplary execution of an instruction to perform a gather operation. The instruction format includes fields for an opcode (V(P)GATHER) that defines the vector gather operation to perform, a field to identify a destination operand, a field to identify a first source operand, and a field to identify a second source operand. In some embodiments, one of the identified first or second source operands is a packed data register which stores a plurality of indices and in total is a source index. Further, in some embodiments, the field for one of the source operands is a plurality of fields to be used to determine a memory (non-register) address.

In this illustrated example, the identified source index 303 has 8 packed data elements (i.e., 8 vector elements or 8 SIMD elements) which do not all store the same value. The identified source memory address(es) 301 reference(s) at least a starting point for gathering data elements from memory. In some embodiments, each element of the source index 303 is used as an index value in a scale-index-base (SIB) type addressing scheme used to generate the source memory address(es) 301.

There are several ways to determine if elements of the identified source index 303 are uniform. In some embodiments, a compiler will assume that they are the same. In other embodiments, uniformity check circuitry 305 within the processor will make this determination. One or more of register rename circuitry, allocation circuitry, and/or scheduler circuitry 313 is used to make this determination similar to detailed above. While these circuits are shown as being a part of execution circuitry 309 it should be understood that one or more of these circuits could be a part of a front end of a processor or processor core. In some embodiments, the uniformity check circuitry 305 includes a plurality of logical ANDs to be used to test elements against each other.

Execution circuitry 309 includes both scalar load operation and broadcast circuitry 307 and packed data gather circuitry 308. The scalar load operation and broadcast circuitry 307 is utilized when there is uniformity within the identified source index 303 and performs a scalar load operation consistent with the vector gather operation dictated by the instruction's opcode and the result of that scalar load operation is broadcast to all of the data element positions of the identified destination operand 311. The packed data gather circuitry 308 is utilized when there is not uniformity within the identified source index operand 303 to perform the vector gather operation dictated by the instruction's opcode by performing individual memory retrievals of data elements at source memory addresses 301 generated using the identified source index 303 and storing each of the retrieved data elements in a corresponding data element position of the identified destination operand 311.

In this example, the packed data gather circuitry 308 is utilized as there is not uniformity of the identified source index operand 303.

In some embodiments, the opcode is an existing opcode to perform a vector gather operation. In other embodiments, the opcode is a different opcode than an existing opcode to perform a vector gather operation and this different opcode indicates that the uniformity check should always occur.

Note too that this illustration is for a simple case wherein only uniformity is considered. As will be detailed later, the uniformity check circuitry 305 may also look for consecutive values in the indices and/or for an indication of clustering in the indices.

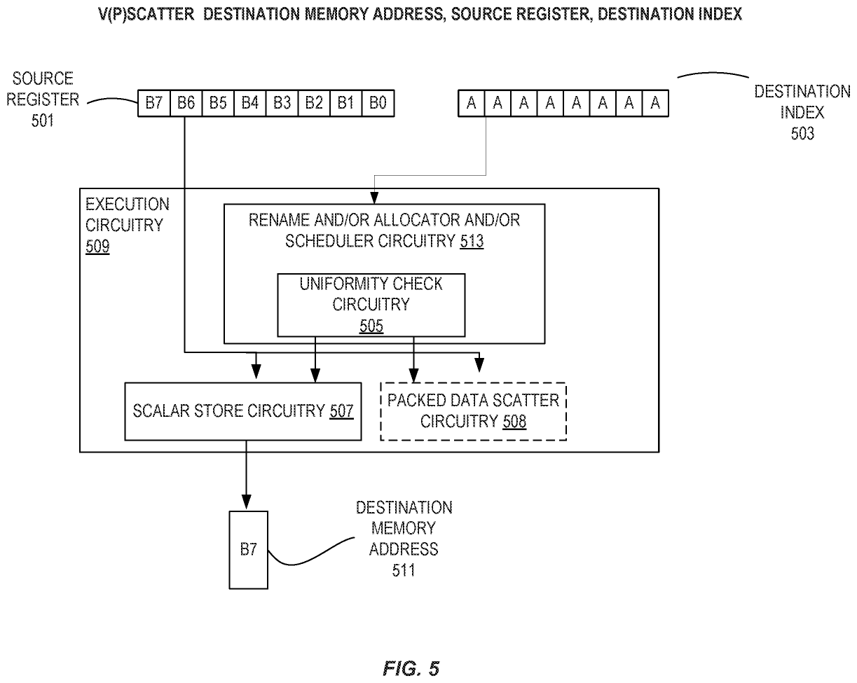

FIG. 5 illustrates an exemplary execution of an instruction to perform a scatter operation. The instruction format includes fields for an opcode (V(P)SCATTER) that defines the vector scatter operation to perform, a field to identify a destination memory address information, a field to identify a first source operand, and a field to identify a second source operand. In some embodiments, one of the identified first or second source operands is a packed data register which stores a plurality of indices and in total is a source index. The other identified source operand stores data to be scattered to memory. Further, in some embodiments, the field for the destination memory location is a plurality of fields to be used to determine a memory (non-register) address.

In this illustrated example, the identified source index 501 has 8 packed data elements (i.e., 8 vector elements or 8 SIMD elements) which all store the same value of “A”. The identified source memory address(es) 501 reference(s) at least a starting point for scattering data elements from memory. In some embodiments, each element of the source index 503 is used as an index value in a scale-index-base (SIB) type addressing scheme used to generate the destination memory address(es) 501.

There are several ways to determine if elements of the identified source index 503 are uniform. In some embodiments, a compiler will assume that they are the same. In other embodiments, uniformity check circuitry 505 within the processor will make this determination. One or more of register rename circuitry, allocation circuitry, and/or scheduler circuitry 513 is used to make this determination similar to detailed above. While these circuits are shown as being a part of execution circuitry 509 it should be understood that one or more of these circuits could be a part of a front end of a processor or processor core. In some embodiments, the uniformity check circuitry 505 includes a plurality of logical ANDs to be used to test elements against each other.

Execution circuitry 509 includes both scalar store operation circuitry 507 and packed data scatter circuitry 508. The scalar store circuitry 507 is utilized when there is uniformity within the identified source index 503 and performs a scalar store operation consistent with the vector scatter operation dictated by the instruction's opcode and the result of that scalar store operation to the destination memory address 511. The packed data scatter circuitry 508 is utilized when there is not uniformity within the identified source index operand 503 to perform the vector scatter operation dictated by the instruction's opcode by performing individual memory storage of data elements of the source memory register 501 at source memory addresses 501 generated using the identified source index 503.

In this example, the scalar store circuitry 507 is utilized as there is uniformity in the identified source index operand 503. Note that since there is a single index value there is only one destination address.

In some embodiments, the opcode is an existing opcode to perform a vector scatter operation. In other embodiments, the opcode is a different opcode than an existing opcode to perform a vector scatter operation and this different opcode indicates that the uniformity check should always occur.

Note too that this illustration is for a simple case wherein only uniformity is considered. As will be detailed later, the uniformity check circuitry 505 may also look for consecutive values in the indices and/or for an indication of clustering in the indices.

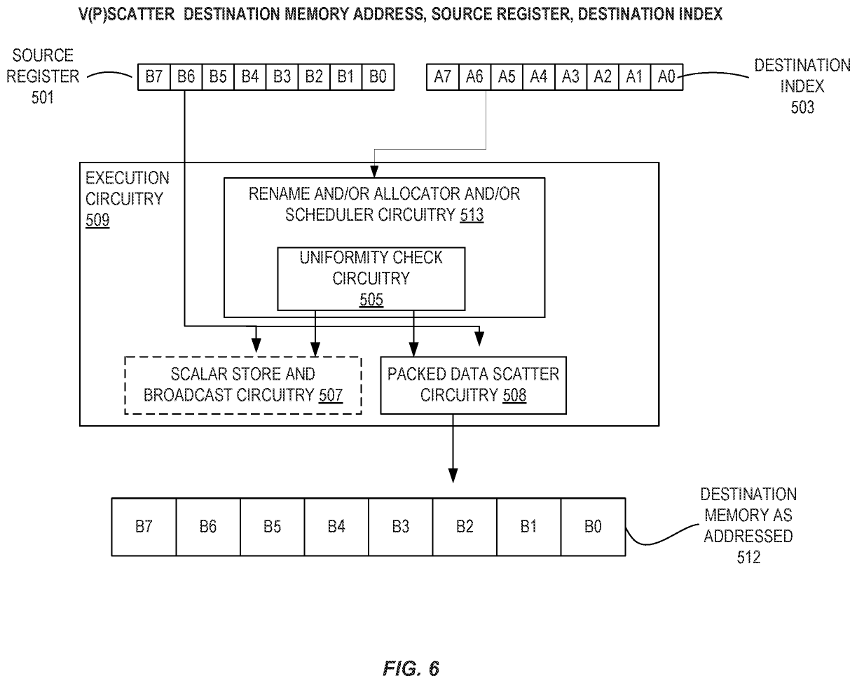

FIG. 6 illustrates an exemplary execution of an instruction to perform a scatter operation. The instruction format includes fields for an opcode (V(P)SCATTER) that defines the vector scatter operation to perform, a field to identify a destination memory address information, a field to identify a first source operand, and a field to identify a second source operand. In some embodiments, one of the identified first or second source operands is a packed data register which stores a plurality of indices and in total is a source index. The other identified source operand stores data to be scattered to memory. Further, in some embodiments, the field for the destination memory location is a plurality of fields to be used to determine a memory (non-register) address.

In this illustrated example, the identified source index 501 has 8 packed data elements (i.e., 8 vector elements or 8 SIMD elements) which do not all store the same value. The identified source memory address(es) 501 reference(s) at least a starting point for scattering data elements from memory. In some embodiments, each element of the source index 503 is used as an index value in a scale-index-base (SIB) type addressing scheme used to generate the destination memory address(es) 501.

There are several ways to determine if elements of the identified source index 503 are uniform. In some embodiments, a compiler will assume that they are the same. In other embodiments, uniformity check circuitry 505 within the processor will make this determination. One or more of register rename circuitry, allocation circuitry, and/or scheduler circuitry 513 is used to make this determination similar to detailed above. While these circuits are shown as being a part of execution circuitry 509 it should be understood that one or more of these circuits could be a part of a front end of a processor or processor core. In some embodiments, the uniformity check circuitry 505 includes a plurality of logical ANDs to be used to test elements against each other.

Execution circuitry 509 includes both scalar store operation circuitry 507 and packed data scatter circuitry 508. The scalar store circuitry 507 is utilized when there is uniformity within the identified source index 503 and performs a scalar store operation consistent with the vector scatter operation dictated by the instruction's opcode and the result of that scalar store operation to the destination memory addresses 512. The packed data scatter circuitry 508 is utilized when there is not uniformity within the identified source index operand 503 to perform the vector scatter operation dictated by the instruction's opcode by performing individual memory storage of data elements of the source memory register 501 at source memory addresses 501 generated using the identified source index 503.

In this example, the packed data scatter circuitry 507 is utilized as there is not uniformity in the identified source index operand 503.

In some embodiments, the opcode is an existing opcode to perform a vector scatter operation. In other embodiments, the opcode is a different opcode than an existing opcode to perform a vector scatter operation and this different opcode indicates that the uniformity check should always occur.

### Exemplary Hardware to Execute the Described Instructions

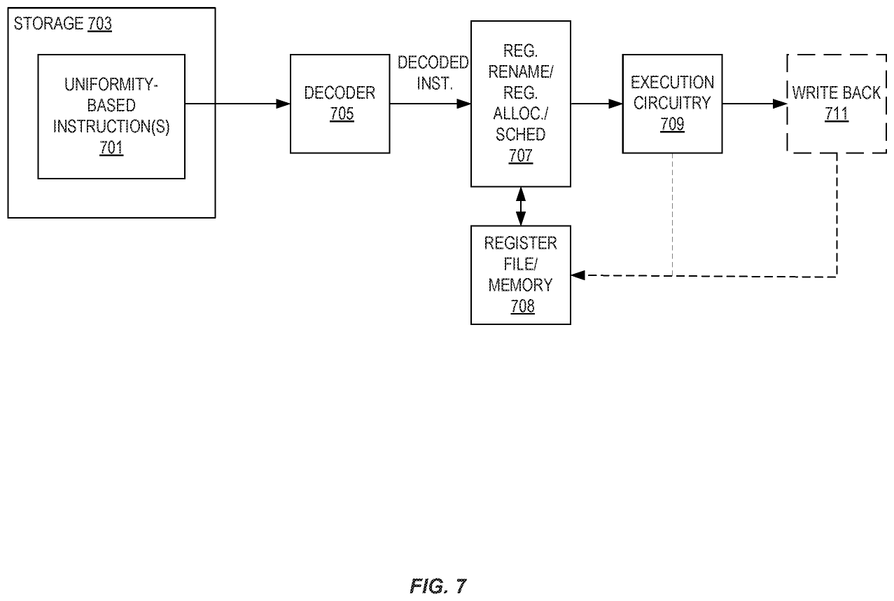

FIG. 7 illustrates an embodiment of hardware to process an instruction such as the uniformity-based instructions detailed herein. As illustrated, storage 701 (such as a disk, memory, etc.) stores the uniformity-based instruction 701 to be executed.

The uniformity-based instruction is received by decode circuitry 705. For example, the decode circuitry 705 receives this instruction from fetch logic/circuitry. The uniformity-based instruction 701 includes fields as detailed above. In some embodiments, the source[s] and destination are registers, and in other embodiments one or more are memory locations. The decode circuitry 705 decodes the instruction into one or more operations. In some embodiments, this decoding includes generating a plurality of micro-operations to be performed by execution circuitry (such as execution circuitry). The decode circuitry 705 also decodes instruction prefixes (if used). Note this decoder circuitry 705 and other decoder circuitry discussed herein provide functionality to decode the new instructions detailed herein. As such, no known decoder is capable of decoding these instructions.

In some embodiments, register renaming, register allocation, and/or scheduling circuitry 707 provides functionality for one or more of: 1) renaming logical operand values to physical operand values (e.g., a register alias table in some embodiments), 2) allocating status bits and flags to the decoded instruction, 3) scheduling the decoded instruction for execution on execution circuitry out of an instruction pool (e.g., using a reservation station in some embodiments), and/or 4) performing uniformity checking.

Registers (register file) and/or memory 708 store data as operands of the instruction to be operated on by execution circuitry. Exemplary register types include packed data registers, general purpose registers, and floating-point registers.

Execution circuitry executes 709 the decoded uniformity-based instruction as detailed herein. Exemplary detailed execution circuitry was shown in FIGS. 1-6. Write back (retirement) circuitry 711 commits the result of the execution of the decoded uniformity-based instruction. Note the execution circuitry is configurable to execute these new decoded instructions.

### Exemplary Formats of the Uniformity-Based Instruction

An embodiment of a format for a uniformity-based logical or arithmetic instruction is VOPERATION DSTREG, SRC1, SRC2. In some embodiments, VOPERATION{B/W/D/Q} is the opcode mnemonic of the instruction for a vector operation and B/W/D/Q are data element sizes. DSTREG is a field for the packed data destination register operand. SRC1 and SRC2 are fields for the sources such as packed data registers and/or memory.

An embodiment of a format for a uniformity-based gather instruction is V(P)GATHER DSTREG, MEM, SRC2. In some embodiments, V(P)GATHER{B/W/D/Q} is the opcode mnemonic of the instruction for a vector operation and B/W/D/Q are data element sizes. DSTREG is a field for the packed data destination register operand. MEM and SRC2 are fields for the sources such as packed data register.

An embodiment of a format for a uniformity-based scatter instruction is V(P)SCATTER MEM, SRC1, SRC2. In some embodiments, V(P)SCATTER{B/W/D/Q} is the opcode mnemonic of the instruction for a vector operation and B/W/D/Q are data element sizes. MEM is a field for the packed data destination memory location. SRC1 and SRC2 are fields for the sources such as packed data registers.

In some embodiments, one or more of the fields or data elements sizes correspond to one or more of fields 1120, 1171, 1164, 1145, 1172, 1150, 1163A or B, etc.

In some embodiments, an instruction includes a field for a writemask register operand (k) (e.g., OPCODE{k} DSTREG, SRC1, SRC2). A writemask is used to conditionally control per-element operations and updating of results. Depending upon the implementation, the writemask uses merging or zeroing masking. Instructions encoded with a predicate (writemask, write mask, or k register) operand use that operand to conditionally control per-element computational operation and updating of result to the destination operand. The predicate operand is known as the opmask (writemask) register. In some embodiments, the opmask is a set of architectural registers of size 64-bit. Note that from this set of architectural registers, only k1 through k7 can be addressed as predicate operand. k0 can be used as a regular source or destination but cannot be encoded as a predicate operand. Note also that a predicate operand can be used to enable memory fault-suppression for some instructions with a memory operand (source or destination). As a predicate operand, the opmask registers contain one bit to govern the operation/update to each data element of a vector register. In general, opmask registers can support instructions with element sizes: single-precision floating-point (float32), integer doubleword(int32), double-precision floating-point (float64), integer quadword (int64). The length of an opmask register, MAX_KL, is sufficient to handle up to 64 elements with one bit per element, i.e. 64 bits. For a given vector length, each instruction accesses only the number of least significant mask bits that are needed based on its data type. An opmask register affects an instruction at per-element granularity. So, any numeric or non-numeric operation of each data element and per-element updates of intermediate results to the destination operand are predicated on the corresponding bit of the opmask register. In most embodiments, an opmask serving as a predicate operand obeys the following properties: 1) the instruction's operation is not performed for an element if the corresponding opmask bit is not set (this implies that no exception or violation can be caused by an operation on a masked-off element, and consequently, no exception flag is updated as a result of a masked-off operation); 2). a destination element is not updated with the result of the operation if the corresponding writemask bit is not set. Instead, the destination element value must be preserved (merging-masking) or it must be zeroed out (zeroing-masking); 3) for some instructions with a memory operand, memory faults are suppressed for elements with a mask bit of 0. Note that this feature provides a versatile construct to implement control-flow predication as the mask in effect provides a merging behavior for vector register destinations. As an alternative the masking can be used for zeroing instead of merging, so that the masked-out elements are updated with 0 instead of preserving the old value. The zeroing behavior is provided to remove the implicit dependency on the old value when it is not needed.

In embodiments, encodings of the instruction include a scale-index-base (SIB) type memory addressing operand that indirectly identifies multiple indexed destination locations in memory. In one embodiment, a SIB type memory operand may include an encoding identifying a base address register. The contents of the base address register may represent a base address in memory from which the addresses of the particular destination locations in memory are calculated. For example, the base address may be the address of the first location in a block of potential destination locations for an extended vector instruction. In one embodiment, a SIB type memory operand may include an encoding identifying an index register. Each element of the index register may specify an index or offset value usable to compute, from the base address, an address of a respective destination location within a block of potential destination locations. In one embodiment, a SIB type memory operand may include an encoding specifying a scaling factor to be applied to each index value when computing a respective destination address. For example, if a scaling factor value of four is encoded in the SIB type memory operand, each index value obtained from an element of the index register may be multiplied by four and then added to the base address to compute a destination address.

In one embodiment, a SIB type memory operand of the form vm32{x,y,z} may identify a vector array of memory operands specified using SIB type memory addressing. In this example, the array of memory addresses is specified using a common base register, a constant scaling factor, and a vector index register containing individual elements, each of which is a 32-bit index value. The vector index register may be a 128-bit register (e.g., XMM) register (vm32x), a 256-bit (e.g., YMM) register (vm32y), or a 512-bit (e.g., ZMM) register (vm32z). In another embodiment, a SIB type memory operand of the form vm64{x,y,z} may identify a vector array of memory operands specified using SIB type memory addressing. In this example, the array of memory addresses is specified using a common base register, a constant scaling factor, and a vector index register containing individual elements, each of which is a 64-bit index value. The vector index register may be a 128-bit register (e.g., XMM) register (vm64x), a 256-bit (e.g., YMM) register (vm64y) or a 512-bit (e.g., ZMM) register (vm64z).

### Exemplary Method of Execution of a Uniformity-Based Logical or Arithmetic Instruction

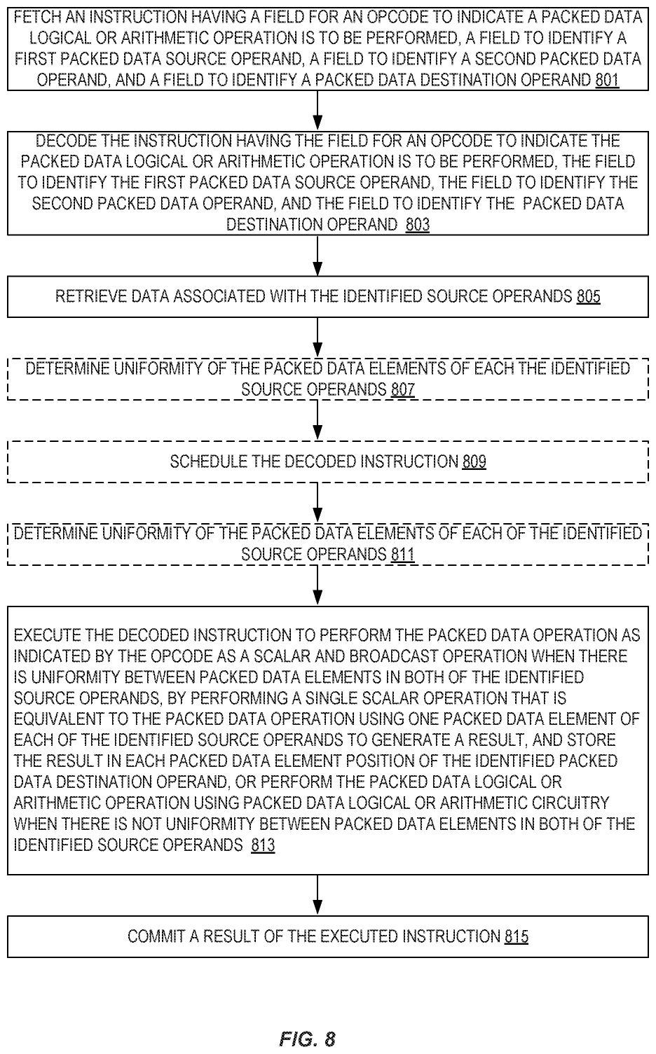

FIG. 8 illustrates an embodiment of method performed by a processor to process a uniformity-based logical or arithmetic instruction. For example, the processor components of FIG. 7, a pipeline as detailed below, etc. performs this method.

At 801, an instruction is fetched. For example, a uniformity-based logical or arithmetic instruction is fetched. The uniformity-based logical or arithmetic instruction includes fields for an opcode, first and second source operand identifiers, and a destination operand identifier. In some embodiments, the instruction further includes a field for a writemask. In some embodiments, the instruction is fetched from an instruction cache. The source operands and destination operand are packed data. The opcode of the uniformity-based logical or arithmetic instruction indicates that execution circuitry is to: 1) perform the packed data logical or arithmetic operation as indicated by the opcode as a scalar and broadcast operation when there is uniformity between packed data elements in both of the identified source operands by performing a single scalar operation using scalar circuitry that is equivalent to the packed data operation using one packed data element of each of the identified source operands to generate a single result and broadcast the single result into each packed data element positions of the identified packed data destination operand, or 2) perform the packed data logical or arithmetic operation using packed data logical or arithmetic circuitry when there is not uniformity between packed data elements in both of the identified source operands.

The fetched instruction is decoded at 803. For example, the fetched instruction is decoded by decode circuitry such as that detailed herein. In some embodiments, this decoded instruction comprises a plurality of micro-operations.

Data values associated with the source operands of the decoded instruction are retrieved at 805 and the decoded instruction is scheduled (as needed). For example, when one or more of the source operands are memory operands, the data from the indicated memory location is retrieved.

In some embodiments, at 807, uniformity of each of the identified packed data source operands is determined using rename and/or allocator circuitry.

In some embodiments, at 809, the decoded instruction is scheduled. In some embodiments, at 807, uniformity of each of the identified packed data source operands is determined using scheduler circuitry.

At 813, the decoded instruction is executed by execution circuitry (hardware) such as that detailed herein. The execution will cause execution circuitry to perform the packed data logical or arithmetic operation as indicated by the opcode as a scalar and broadcast operation when there is uniformity between packed data elements in both of the identified source operands by performing a single scalar operation using scalar circuitry that is equivalent to the packed data operation using one packed data element of each of the identified source operands to generate a single result and broadcast the single result into each packed data element positions of the identified packed data destination operand, or 2) perform the packed data logical or arithmetic operation using packed data logical or arithmetic circuitry when there is not uniformity between packed data elements in both of the identified source operands

In some embodiments, the instruction is committed or retired at 815.

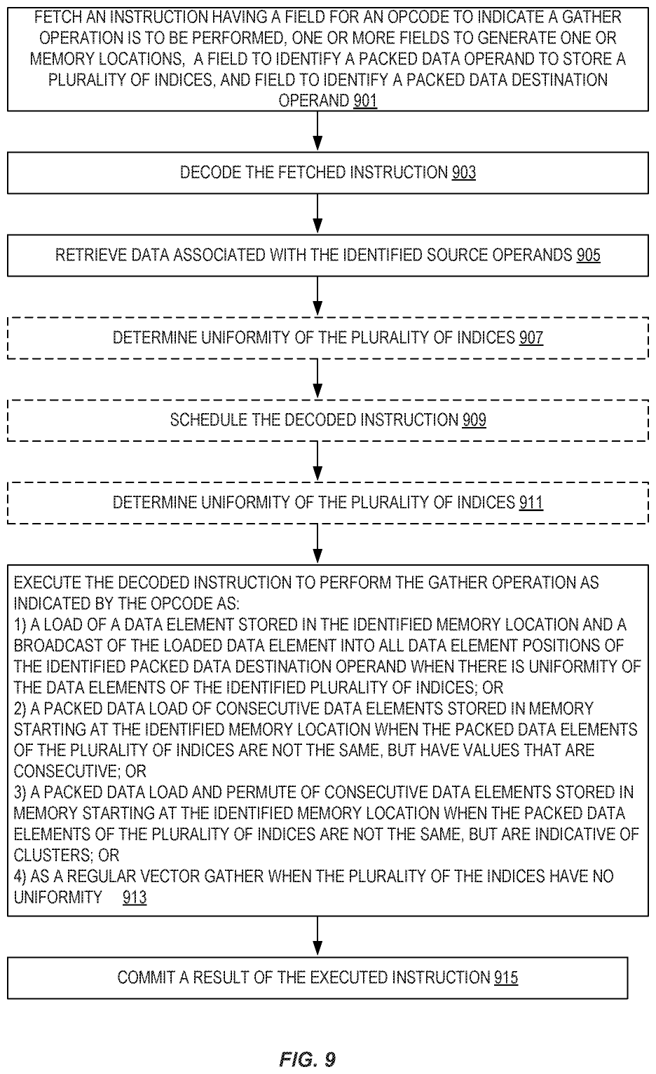

FIG. 9 illustrates an embodiment of method performed by a processor to process a uniformity-based gather instruction. For example, the processor components of FIG. 7, a pipeline as detailed below, etc. performs this method.

At 901, an instruction is fetched. For example, a uniformity-gather instruction is fetched. The uniformity-based gather instruction includes a field for an opcode, a field to identify a source operand to store a plurality of indexes, one or more fields to generate one or source memory locations, and field for a destination operand identifier. In some embodiments, the instruction further includes a field for a writemask. In some embodiments, the instruction is fetched from an instruction cache.

The opcode of the uniformity-based gather instruction indicates that execution circuitry may perform a packed data gather operation equivalent as: 1) a load of a data element stored in the identified memory location and a broadcast of the loaded data element into all data element positions of the identified packed data destination operand when there is uniformity of the data elements of the identified plurality of indices; or 2) a packed data load of consecutive data elements stored in memory starting at the identified memory location when the packed data elements of the plurality of indices are not the same, but have values that are consecutive; or 3) a packed data load and permute of consecutive data elements stored in memory starting at the identified memory location when the packed data elements of the plurality of indices are not the same, but are indicative of clusters; or 4) as a regular vector gather when the plurality of the indices have no uniformity (and, depending on the implementation, are not consecutive or indicative of clusters). Note that the source memory location(s) is/are generated using SIB addressing.

Note that not all 4 of the potential operations may be utilized in a given implementation. For example, potential operations 2 and 3 may not be available and only 1 and 4 would be possible in that instance.

The fetched instruction is decoded at 903. For example, the fetched instruction is decoded by decode circuitry such as that detailed herein. In some embodiments, this decoded instruction comprises a plurality of micro-operations.

Data values associated with the packed data operand to store the plurality of indices is retrieved at 905 and the decoded instruction is scheduled (as needed).

In some embodiments, at 907, uniformity of each of the identified plurality of indices is determined using rename and/or allocator circuitry.

In some embodiments, at 909, the decoded instruction is scheduled. In some embodiments, at 907, uniformity of each of the identified plurality of indices is determined using scheduler circuitry.

At 913, the decoded instruction is executed by execution circuitry (hardware) such as that detailed herein. The execution will cause execution circuitry to perform a packed data gather operation as indicated by the opcode as: 1) a load of a data element stored in the identified memory location and a broadcast of the loaded data element into all data element positions of the identified packed data destination operand when there is uniformity of the data elements of the identified plurality of indices; or 2) a packed data load of consecutive data elements stored in memory starting at the identified memory location when the packed data elements of the plurality of indices are not the same, but have values that are consecutive; or 3) a packed data load and permute of consecutive data elements stored in memory starting at the identified memory location when the packed data elements of the plurality of indices are not the same, but are indicative of clusters; or 4) as a regular vector gather when the plurality of the indices have no uniformity (and, depending on the implementation, are not consecutive or indicative of clusters).

In some embodiments, the instruction is committed or retired at 915.

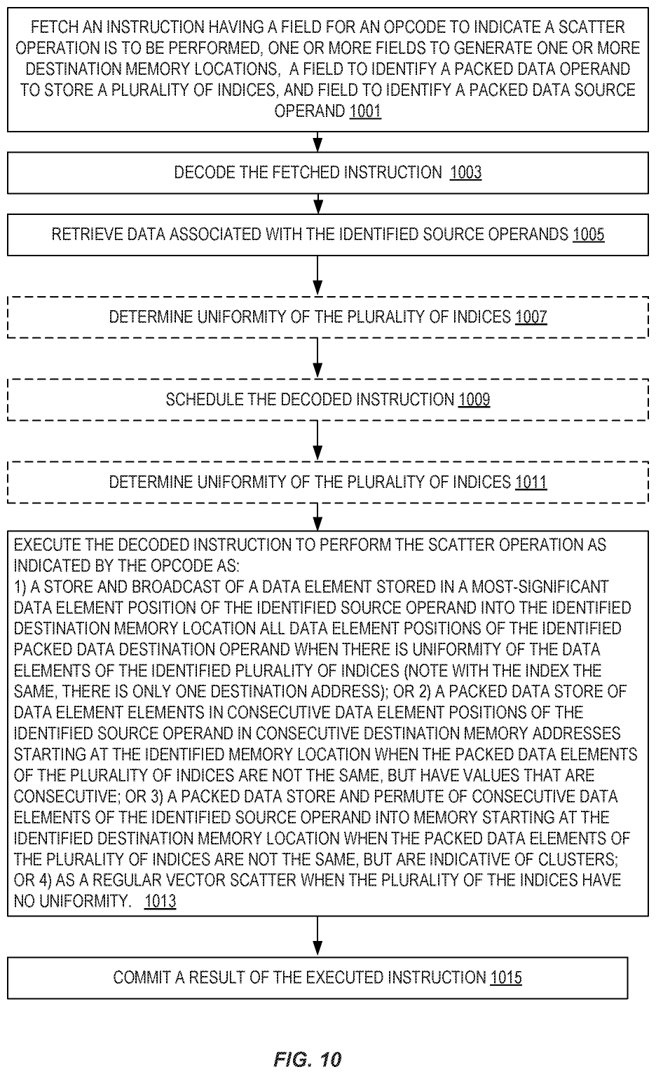

FIG. 10 illustrates an embodiment of method performed by a processor to process a uniformity-based scatter instruction. For example, the processor components of FIG. 7, a pipeline as detailed below, etc. performs this method.

At 1001, an instruction is fetched. For example, a uniformity-scatter instruction is fetched. The uniformity-based scatter instruction includes a field for an opcode, a field to identify a source operand to store a plurality of indexes, one or more fields to generate one or destination memory locations, and field for a source operand identifier. In some embodiments, the instruction further includes a field for a writemask. In some embodiments, the instruction is fetched from an instruction cache.

The opcode of the uniformity-based scatter instruction indicates that execution circuitry may perform a packed data scatter operation equivalent as: 1) a store and broadcast of a data element stored in a most-significant data element position of the identified source operand into the identified destination memory location all data element positions of the identified packed data destination operand when there is uniformity of the data elements of the identified plurality of indices (note with the index the same, there is only one destination address); or 2) a packed data store of data element elements in consecutive data element positions of the identified source operand in consecutive destination memory addresses starting at the identified memory location when the packed data elements of the plurality of indices are not the same, but have values that are consecutive; or 3) a packed data store and permute of consecutive data elements of the identified source operand into memory starting at the identified destination memory location when the packed data elements of the plurality of indices are not the same, but are indicative of clusters; or 4) as a regular vector scatter when the plurality of the indices have no uniformity (and, depending on the implementation, are not consecutive or indicative of clusters). Note that the destination memory location(s) is/are generated using SIB addressing.

Note that not all 4 of the potential operations may be utilized in a given implementation. For example, potential operations 2 and 3 may not be available and only 1 and 4 would be possible in that instance.

The fetched instruction is decoded at 1003. For example, the fetched instruction is decoded by decode circuitry such as that detailed herein. In some embodiments, this decoded instruction comprises a plurality of micro-operations.

Data values associated with the packed data operand to store the plurality of indices is retrieved at 1005 and the decoded instruction is scheduled (as needed).

In some embodiments, at 1007, uniformity of each of the identified plurality of indices is determined using rename and/or allocator circuitry.

In some embodiments, at 1009, the decoded instruction is scheduled. In some embodiments, at 1007, uniformity of each of the identified plurality of indices is determined using scheduler circuitry.

At 1013, the decoded instruction is executed by execution circuitry (hardware) such as that detailed herein. The execution will cause execution circuitry to perform a packed data scatter operation as indicated by the opcode as: 1) a store of a data element stored in the identified memory location and a broadcast of the stored data element into all data element positions of the identified packed data destination operand when there is uniformity of the data elements of the identified plurality of indices; or 2) a packed data store of consecutive data elements stored in memory starting at the identified memory location when the packed data elements of the plurality of indices are not the same, but have values that are consecutive; or 3) a packed data store and permute of consecutive data elements store in memory starting at the identified memory location when the packed data elements of the plurality of indices are not the same, but are indicative of clusters; or 4) as a regular vector scatter when the plurality of the indices have no uniformity (and, depending on the implementation, are not consecutive or indicative of clusters).

In some embodiments, the instruction is committed or retired at 1015.

Detailed below are exemplary instruction formats, architectures, and systems that may be utilized for the above detailed instructions. For example, an exemplary pipeline supporting the instructions is detailed that includes circuitry to perform the methods detailed herein.

Instruction Sets

An instruction set may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. A set of SIMD extensions referred to as the Advanced Vector Extensions (AVX) (AVX1 and AVX2) and using the Vector Extensions (VEX) coding scheme has been released and/or published (e.g., see Intel® 64 and IA-32 Architectures Software Developer's Manual, September 2014; and see Intel® Advanced Vector Extensions Programming Reference, October 2014).

Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

While embodiments of the invention will be described in which the vector friendly instruction format supports the following: a 64 byte vector operand length (or size) with 32 bit (4 byte) or 64 bit (8 byte) data element widths (or sizes) (and thus, a 64 byte vector consists of either 16 doubleword-size elements or alternatively, 8 quadword-size elements); a 64 byte vector operand length (or size) with 16 bit (2 byte) or 8 bit (1 byte) data element widths (or sizes); a 32 byte vector operand length (or size) with 32 bit (4 byte), 64 bit (8 byte), 16 bit (2 byte), or 8 bit (1 byte) data element widths (or sizes); and a 16 byte vector operand length (or size) with 32 bit (4 byte), 64 bit (8 byte), 16 bit (2 byte), or 8 bit (1 byte) data element widths (or sizes); alternative embodiments may support more, less and/or different vector operand sizes (e.g., 256 byte vector operands) with more, less, or different data element widths (e.g., 128 bit (16 byte) data element widths).

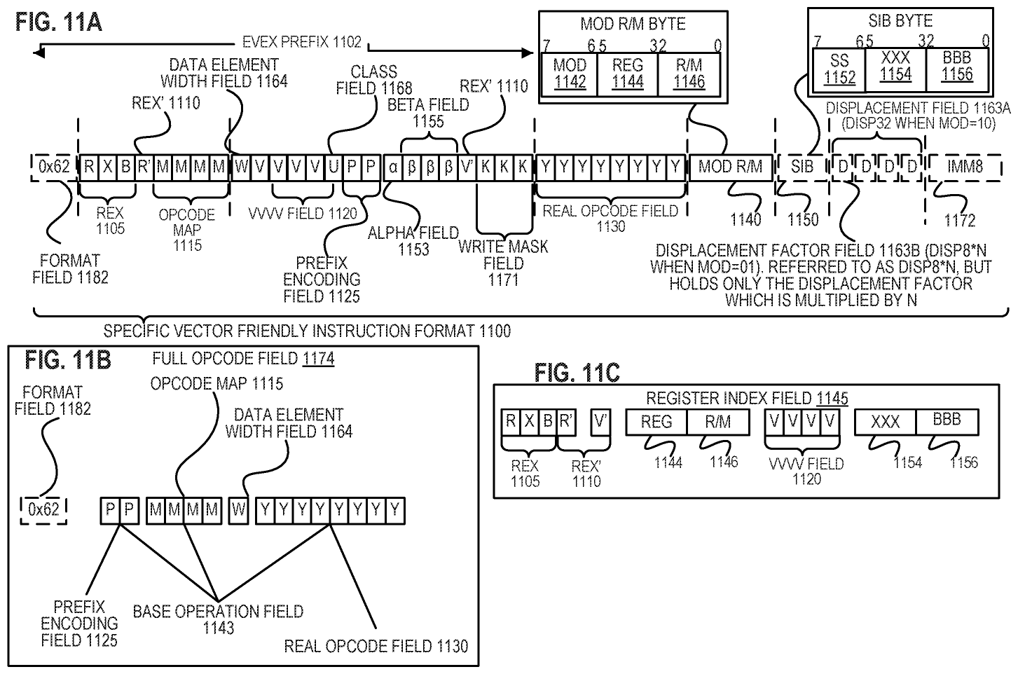

FIG. 11A is a block diagram illustrating an exemplary instruction format according to embodiments of the invention. FIG. 11A shows a instruction format 1100 that is specific in the sense that it specifies the location, size, interpretation, and order of the fields, as well as values for some of those fields. The instruction format 1100 may be used to extend the x86 instruction set, and thus some of the fields are similar or the same as those used in the existing x86 instruction set and extension thereof (e.g., AVX). This format remains consistent with the prefix encoding field, real opcode byte field, MOD RIM field, SIB field, displacement field, and immediate fields of the existing x86 instruction set with extensions.

EVEX Prefix (Bytes 0-3) 1102—is encoded in a four-byte form.

Format Field 1182 (EVEX Byte 0, bits [7:0])—the first byte (EVEX Byte 0) is the format field 1182 and it contains 0x62 (the unique value used for distinguishing the vector friendly instruction format in one embodiment of the invention).

The second-fourth bytes (EVEX Bytes 1-3) include a number of bit fields providing specific capability.

REX field 1105 (EVEX Byte 1, bits [7-5])—consists of a EVEX.R bit field (EVEX Byte 1, bit [7]—R), EVEX.X bit field (EVEX byte 1, bit [6]—X), and 1157BEX byte 1, bit[5]—B). The EVEX.R, EVEX.X, and EVEX.B bit fields provide the same functionality as the corresponding VEX bit fields, and are encoded using 1s complement form, i.e. ZMM0 is encoded as 1111B, ZMM15 is encoded as 0000B. Other fields of the instructions encode the lower three bits of the register indexes as is known in the art (rrr, xxx, and bbb), so that Rrrr, Xxxx, and Bbbb may be formed by adding EVEX.R, EVEX.X, and EVEX.B.

REX′ field 1110—this is is the EVEX.R′ bit field (EVEX Byte 1, bit [4]—R′) that is used to encode either the upper 16 or lower 16 of the extended 32 register set. In one embodiment of the invention, this bit, along with others as indicated below, is stored in bit inverted format to distinguish (in the well-known x86 32-bit mode) from the BOUND instruction, whose real opcode byte is 62, but does not accept in the MOD RIM field (described below) the value of 11 in the MOD field; alternative embodiments of the invention do not store this and the other indicated bits below in the inverted format. A value of 1 is used to encode the lower 16 registers. In other words, R′Rrrr is formed by combining EVEX.R′, EVEX.R, and the other RRR from other fields.

Opcode map field 1115 (EVEX byte 1, bits [3:0]—mmmm)—its content encodes an implied leading opcode byte (0F, 0F 38, or 0F 3).

Data element width field 1164 (EVEX byte 2, bit [7]—W)—is represented by the notation EVEX.W. EVEX.W is used to define the granularity (size) of the datatype (either 32-bit data elements or 64-bit data elements). This field is optional in the sense that it is not needed if only one data element width is supported and/or data element widths are supported using some aspect of the opcodes.

EVEX.vvvv 1120 (EVEX Byte 2, bits [6:3]-vvvv)—the role of EVEX.vvvv may include the following: 1) EVEX.vvvv encodes the first source register operand, specified in inverted (1s complement) form and is valid for instructions with 2 or more source operands; 2) EVEX.vvvv encodes the destination register operand, specified in 1s complement form for certain vector shifts; or 3) EVEX.vvvv does not encode any operand, the field is reserved and should contain 1111b. Thus, EVEX.vvvv field 1120 encodes the 4 low-order bits of the first source register specifier stored in inverted (1s complement) form. Depending on the instruction, an extra different EVEX bit field is used to extend the specifier size to 32 registers.

EVEX.U 1168 Class field (EVEX byte 2, bit [2]-U)—If EVEX.0=0, it indicates class A (support merging-writemasking) or EVEX.U0; if EVEX.0=1, it indicates class B (support zeroing and merging-writemasking) or EVEX.U1.

Prefix encoding field 1125 (EVEX byte 2, bits [1:0]-pp)—provides additional bits for the base operation field. In addition to providing support for the legacy SSE instructions in the EVEX prefix format, this also has the benefit of compacting the SIMD prefix (rather than requiring a byte to express the SIMD prefix, the EVEX prefix requires only 2 bits). In one embodiment, to support legacy SSE instructions that use a SIMD prefix (66H, F2H, F3H) in both the legacy format and in the EVEX prefix format, these legacy SIMD prefixes are encoded into the SIMD prefix encoding field; and at runtime are expanded into the legacy SIMD prefix prior to being provided to the decoder's PLA (so the PLA can execute both the legacy and EVEX format of these legacy instructions without modification). Although newer instructions could use the EVEX prefix encoding field's content directly as an opcode extension, certain embodiments expand in a similar fashion for consistency but allow for different meanings to be specified by these legacy SIMD prefixes. An alternative embodiment may redesign the PLA to support the 2 bit SIMD prefix encodings, and thus not require the expansion.

Alpha field 1153 (EVEX byte 3, bit [7]—EH; also known as EVEX.EH, EVEX.rs, EVEX.RL, EVEX.writemask control, and EVEX.N; also illustrated with α)—its content content distinguishes which one of the different augmentation operation types are to be performed.

Beta field 1155 (EVEX byte 3, bits [6:4]—SSS, also known as EVEX.s₂₋₀, EVEX.r₂₋₀, EVEX.rr1, EVEX.LL0, EVEX.LLB; also illustrated with βββ)—distinguishes which of the operations of a specified type are to be performed.

REX′ field 1110—this is the remainder of the REX′ field and is the EVEX.V′ bit field (EVEX Byte 3, bit [3]—V′) that may be used to encode either the upper 16 or lower 16 of the extended 32 register set. This bit is stored in bit inverted format. A value of 1 is used to encode the lower 16 registers. In other words, V′VVVV is formed by combining EVEX.V′, EVEX.vvvv.

Writemask field 1171 (EVEX byte 3, bits [2:0]-kkk)—its content specifies the index of a register in the writemask registers. In one embodiment of the invention, the specific value EVEX.kkk=000 has a special behavior implying no writemask is used for the particular instruction (this may be implemented in a variety of ways including the use of a writemask hardwired to all ones or hardware that bypasses the masking hardware). When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the writemask field 1171 allows for partial vector operations, including loads, stores, arithmetic, logical, etc. While embodiments of the invention are described in which the writemask field's 1171 content selects one of a number of writemask registers that contains the writemask to be used (and thus the writemask field's 1171 content indirectly identifies that masking to be performed), alternative embodiments instead or additional allow the mask write field's 1171 content to directly specify the masking to be performed.

Real Opcode Field 1130 (Byte 4) is also known as the opcode byte. Part of the opcode is specified in this field.

MOD R/M Field 1140 (Byte 5) includes MOD field 1142, register index field 1144, and R/M field 1146. The MOD field's 1142 content distinguishes between memory access and non-memory access operations. The role of register index field 1144 can be summarized to two situations: encoding either the destination register operand or a source register operand, or be treated as an opcode extension and not used to encode any instruction operand. The content of register index field 1144, directly or through address generation, specifies the locations of the source and destination operands, be they in registers or in memory. These include a sufficient number of bits to select N registers from a P×Q (e.g. 32×512, 16×128, 32×1024, 64×1024) register file. While in one embodiment N may be up to three sources and one destination register, alternative embodiments may support more or less sources and destination registers (e.g., may support up to two sources where one of these sources also acts as the destination, may support up to three sources where one of these sources also acts as the destination, may support up to two sources and one destination).

The role of R/M field 1146 may include the following: encoding the instruction operand that references a memory address, or encoding either the destination register operand or a source register operand.

Scale, Index, Base (SIB) Byte (Byte 6)—The scale field's 1150 content allows for the scaling of the index field's content for memory address generation (e.g., for address generation that uses 2^{scale}*index+base). SIB.xxx 1154 and SIB.bbb 1156—the contents of these fields have been previously referred to with regard to the register indexes Xxxx and Bbbb.

Displacement field 1163A (Bytes 7-10)—when MOD field 1142 contains 10, bytes 7-10 are the displacement field 1163A, and it works the same as the legacy 32-bit displacement (disp32) and works at byte granularity. This may be used as part of memory address generation (e.g., for address generation that uses 2^{scale}*index+base+displacement).

Displacement factor field 1163B (Byte 7)—when MOD field 1142 contains 01, byte 7 is the displacement factor field 1163B. The location of this field is that same as that of the legacy x86 instruction set 8-bit displacement (disp8), which works at byte granularity. Since disp8 is sign extended, it can only address between −128 and 127 bytes offsets; in terms of 64 byte cache lines, disp8 uses 8 bits that can be set to only four really useful values −128, −64, 0, and 64; since a greater range is often needed, disp32 is used; however, disp32 requires 4 bytes. In contrast to disp8 and disp32, the displacement factor field 1163B is a reinterpretation of disp8; when using displacement factor field 1163B, the actual displacement is determined by the content of the displacement factor field multiplied by the size of the memory operand access (N). This type of displacement is referred to as disp8*N. This reduces the average instruction length (a single byte of used for the displacement but with a much greater range). Such compressed displacement is based on the assumption that the effective displacement is multiple of the granularity of the memory access, and hence, the redundant low-order bits of the address offset do not need to be encoded. In other words, the displacement factor field 1163B substitutes the legacy x86 instruction set 8-bit displacement. Thus, the displacement factor field 1163B is encoded the same way as an x86 instruction set 8-bit displacement (so no changes in the ModRM/SIB encoding rules) with the only exception that disp8 is overloaded to disp8*N. In other words, there are no changes in the encoding rules or encoding lengths but only in the interpretation of the displacement value by hardware (which needs to scale the displacement by the size of the memory operand to obtain a byte-wise address offset).

Immediate field 1172 allows for the specification of an immediate. This field is optional in the sense that is it not present in an implementation of the generic vector friendly format that does not support immediate and it is not present in instructions that do not use an immediate.

Full Opcode Field

FIG. 11B is a block diagram illustrating the fields of the instruction format 1100 that make up the full opcode field 1174 according to one embodiment of the invention. Specifically, the full opcode field 1174 includes the format field 1182, the base operation field 1143, and the data element width (W) field 1163. The base operation field 1143 includes the prefix encoding field 1125, the opcode map field 1115, and the real opcode field 1130.

Register Index Field

FIG. 11C is a block diagram illustrating the fields of the format 1100 that make up the register index field 1145 according to one embodiment of the invention. Specifically, the register index field 1145 includes the REX field 1105, the REX′ field 1110, the MODR/M.reg field 1144, the MODR/M.r/m field 1146, the VVVV field 1120, xxx field 1154, and the bbb field 1156. Augmentation Operation Field

FIG. 11D is a block diagram illustrating the fields of the instruction format 1100 that make up an augmentation operation field according to one embodiment of the invention. When the class (U) field 1168 contains 0, it signifies EVEX.U0 (class A 1168A); when it contains 1, it signifies EVEX.U1 (class B 1168B). When U=0 and the MOD field 1142 contains 11 (signifying a no memory access operation), the alpha field 1153 (EVEX byte 3, bit [7]—EH) is interpreted as the rs field 1153A. When the rs field 1153A contains a 1 (round 1153A.1), the beta field 1155 (EVEX byte 3, bits [6:4]—SSS) is interpreted as the round control field 1155A. The round control field 1155A includes a one bit SAE field 1196 and a two bit round operation field 1198. When the rs field 1153A contains a 0 (data transform 1153A.2), the beta field 1155 (EVEX byte 3, bits [6:4]—SSS) is interpreted as a three bit data transform field 1155B. When U=0 and the MOD field 1142 contains 00, 01, or 10 (signifying a memory access operation), the alpha field 1153 (EVEX byte 3, bit [7]—EH) is interpreted as the eviction hint (EH) field 1153B and the beta field 1155 (EVEX byte 3, bits [6:4]—SSS) is interpreted as a three bit data manipulation field 1155C.

When U=1, the alpha field 1153 (EVEX byte 3, bit [7]—EH) is interpreted as the writemask control (Z) field 1153C. When U=1 and the MOD field 1142 contains 11 (signifying a no memory access operation), part of the beta field 1155 (EVEX byte 3, bit [4]—S₀) is interpreted as the RL field 1157A; when it contains a 1 (round 1157A.1) the rest of the beta field 1155 (EVEX byte 3, bit [6-5]—S₂₋₁) is interpreted as the round operation field 1159A, while when the RL field 1157A contains a 0 (VSIZE 1157.A2) the rest of the beta field 1155 (EVEX byte 3, bit [6-5]—S₂₋₁) is interpreted as the vector length field 1159B (EVEX byte 3, bit [6-5]—L₁₋₀). When U=1 and the MOD field 1142 contains 00, 01, or 10 (signifying a memory access operation), the beta field 1155 (EVEX byte 3, bits [6:4]—SSS) is interpreted as the vector length field 1159B (EVEX byte 3, bit [6-5]—L₁₋₀) and the broadcast field 1157B (EVEX byte 3, bit [4]—B).

Exemplary Register Architecture

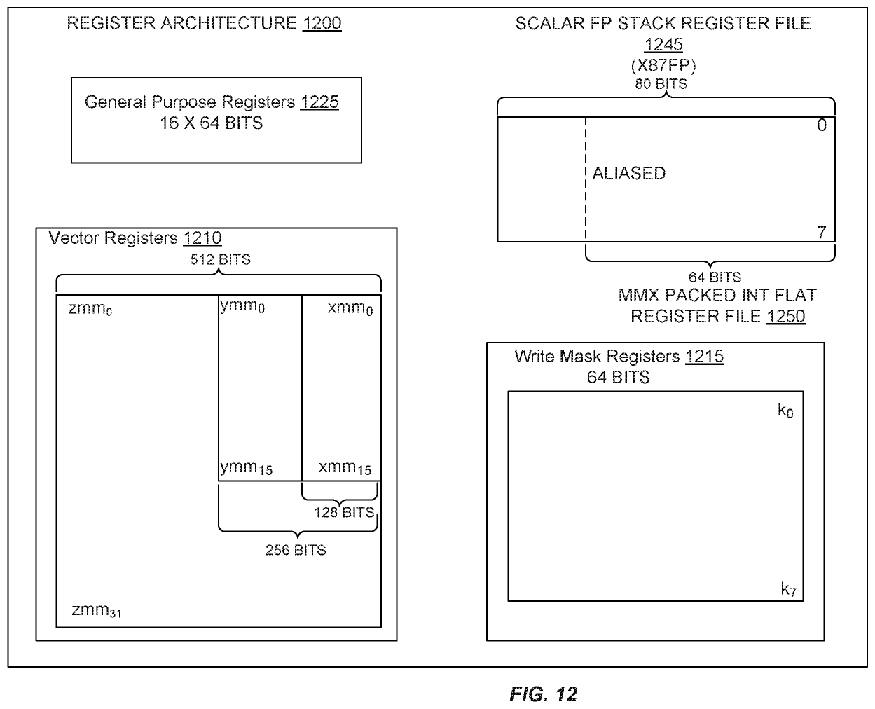

FIG. 12 is a block diagram of a register architecture 1200 according to one embodiment of the invention. In the embodiment illustrated, there are 32 vector registers 1210 that are 512 bits wide; these registers are referenced as ZMM0 through ZMM31. The lower order 256 bits of the lower 16 ZMM registers are overlaid on registers YMM0-16. The lower order 128 bits of the lower 16 ZMM registers (the lower order 128 bits of the YMM registers) are overlaid on registers XMM0-15. In other words, the vector length field 1159B selects between a maximum length and one or more other shorter lengths, where each such shorter length is half the length of the preceding length; and instructions templates without the vector length field 1159B operate on the maximum vector length. Further, in one embodiment, the class B instruction templates of the instruction format 1100 operate on packed or scalar single/double-precision floating point data and packed or scalar integer data. Scalar operations are operations performed on the lowest order data element position in a ZMM/YMM/XMM register; the higher order data element positions are either left the same as they were prior to the instruction or zeroed depending on the embodiment.

Writemask registers 1215—in the embodiment illustrated, there are 8 writemask registers (k0 through k7), each 64 bits in size. In an alternate embodiment, the writemask registers 1215 are 16 bits in size. In some embodiments, the vector mask register k0 cannot be used as a writemask; when the encoding that would normally indicate k0 is used for a writemask, it selects a hardwired writemask of 0xFFFF, effectively disabling writemasking for that instruction.

General-purpose registers 1225—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 1245, on which is aliased the MMX packed integer flat register file 1250—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative embodiments of the invention may use wider or narrower registers. Additionally, alternative embodiments of the invention may use more, less, or different register files and registers.

Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

Exemplary Core Architectures

In-Order and Out-of-Order Core Block Diagram

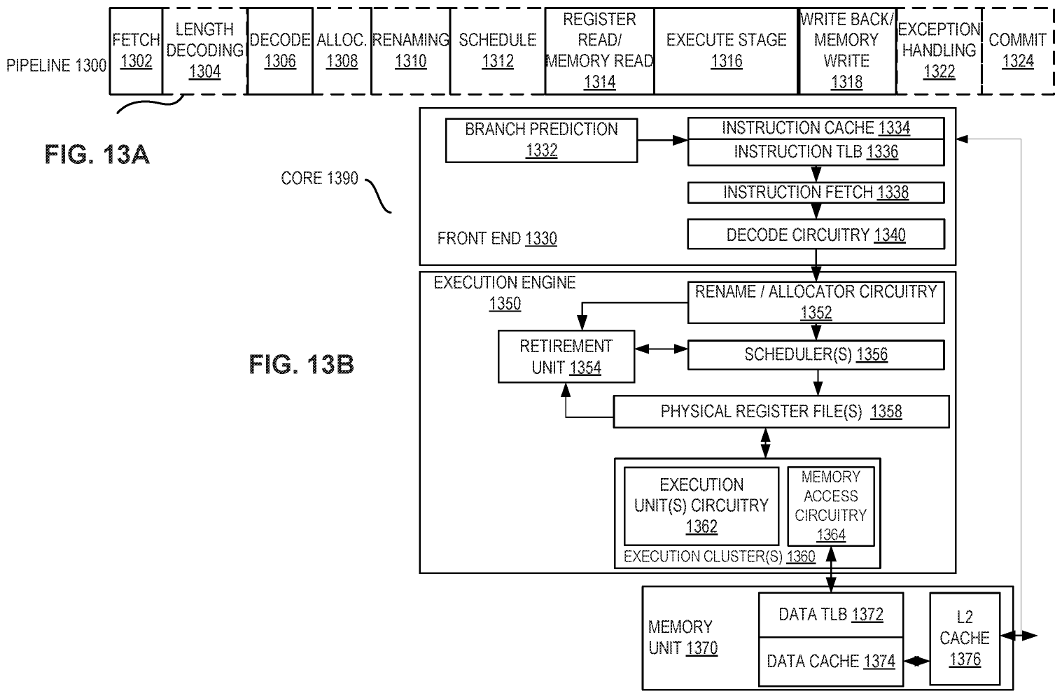

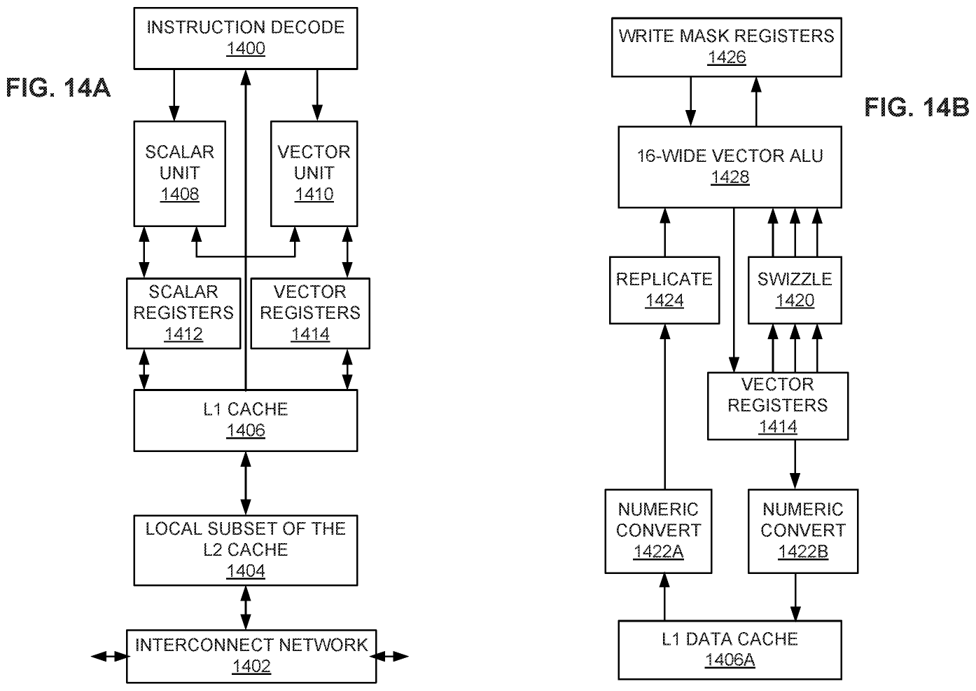

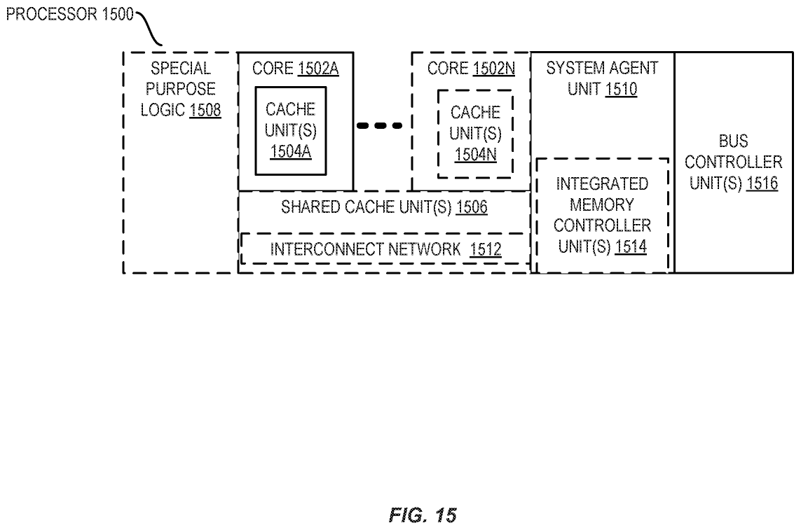

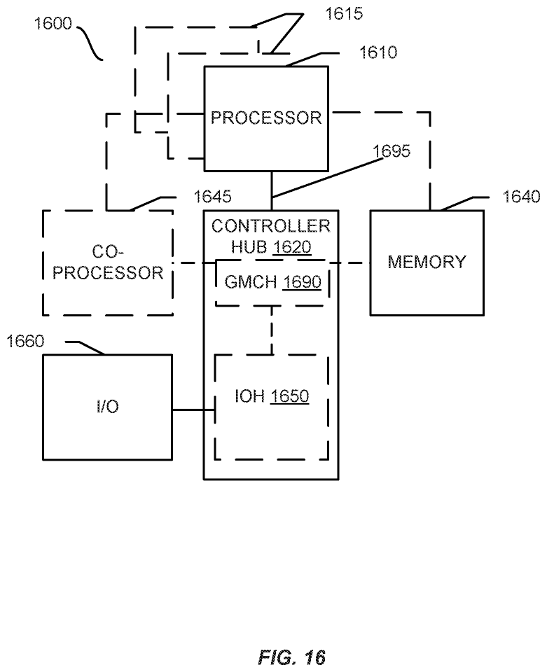

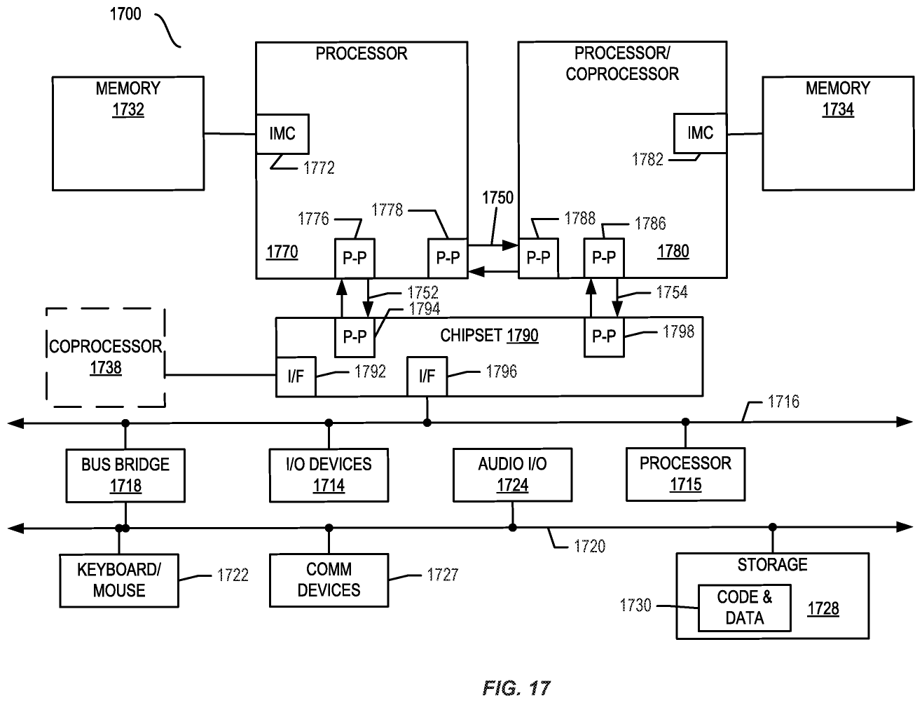

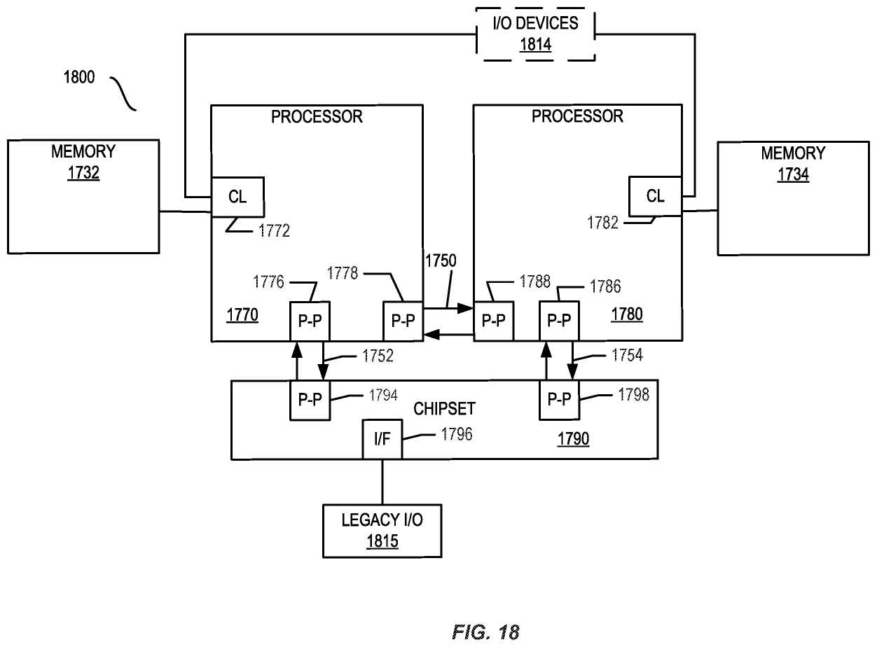

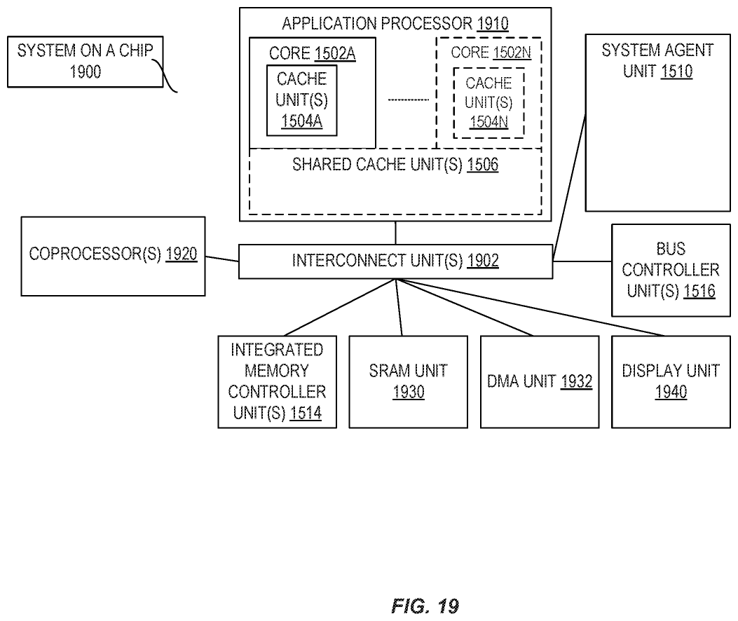

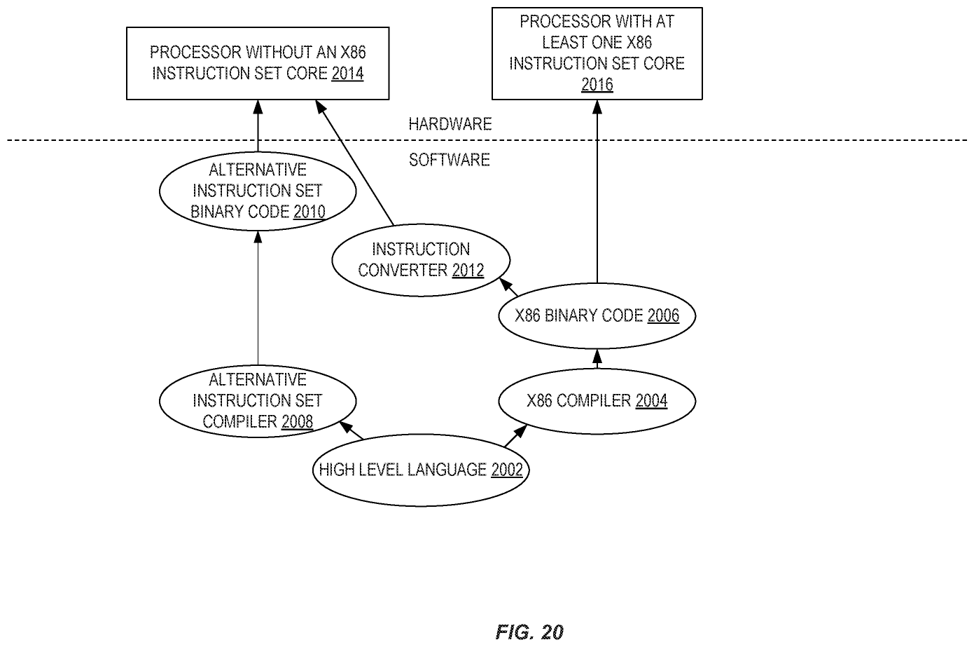

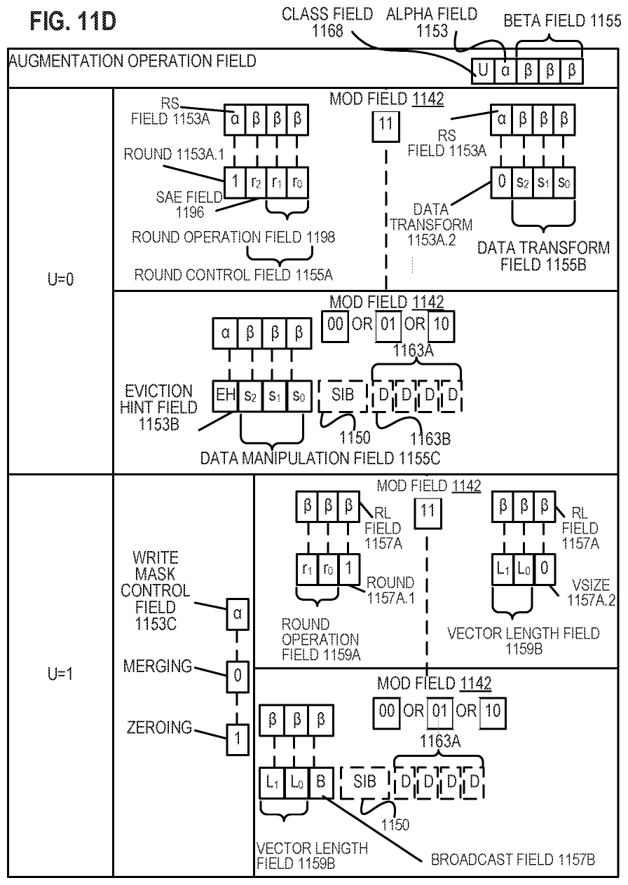

FIG. 13A is a block diagram illustrating both an exemplary in-order pipeline and an exemplary register renaming, out-of-order issue/execution pipeline according to embodiments of the invention. FIG. 13B is a block diagram illustrating both an exemplary embodiment of an in-order architecture core and an exemplary register renaming, out-of-order issue/execution architecture core to be included in a processor according to embodiments of the invention. The solid lined boxes in FIGS. 13A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 13A, a processor pipeline 1300 includes a fetch stage 1302, a length decode stage 1304, a decode stage 1306, an allocation stage 1308, a renaming stage 1310, a scheduling (also known as a dispatch or issue) stage 1312, a register read/memory read stage 1314, an execute stage 1316, a write back/memory write stage 1318, an exception handling stage 1322, and a commit stage 1324.

FIG. 13B shows processor core 1390 including a front end unit 1330 coupled to an execution engine unit 1350, and both are coupled to a memory unit 1370. The core 1390 may be a reduced instruction set computing (RISC) core, a complex instruction set computing (CISC) core, a very long instruction word (VLIW) core, or a hybrid or alternative core type. As yet another option, the core 1390 may be a special-purpose core, such as, for example, a network or communication core, compression engine, coprocessor core, general purpose computing graphics processing unit (GPGPU) core, graphics core, or the like.

The front end unit 1330 includes a branch prediction unit 1332 coupled to an instruction cache unit 1334, which is coupled to an instruction translation lookaside buffer (TLB) 1336, which is coupled to an instruction fetch unit 1338, which is coupled to a decode unit 1340. The decode unit 1340 (or decoder) may decode instructions, and generate as an output one or more micro-operations, micro-code entry points, microinstructions, other instructions, or other control signals, which are decoded from, or which otherwise reflect, or are derived from, the original instructions. The decode unit 1340 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1390 includes a microcode ROM or other medium that stores microcode for certain macroinstructions (e.g., in decode unit 1340 or otherwise within the front end unit 1330). The decode unit 1340 is coupled to a rename/allocator unit 1352 in the execution engine unit 1350.

The execution engine unit 1350 includes the rename/allocator unit 1352 coupled to a retirement unit 1354 and a set of one or more scheduler unit(s) 1356. The scheduler unit(s) 1356 represents any number of different schedulers, including reservations stations, central instruction window, etc. The scheduler unit(s) 1356 is coupled to the physical register file(s) unit(s) 1358. Each of the physical register file(s) units 1358 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 1358 comprises a vector registers unit, a writemask registers unit, and a scalar registers unit. These register units may provide architectural vector registers, vector mask registers, and general purpose registers. The physical register file(s) unit(s) 1358 is overlapped by the retirement unit 1354 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 1354 and the physical register file(s) unit(s) 1358 are coupled to the execution cluster(s) 1360. The execution cluster(s) 1360 includes a set of one or more execution units 1362 and a set of one or more memory access units 1364. The execution units 1362 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1356, physical register file(s) unit(s) 1358, and execution cluster(s) 1360 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1364). It should also be understood that where separate pipelines are used, one or more of these pipelines may be out-of-order issue/execution and the rest in-order.

The set of memory access units 1364 is coupled to the memory unit 1370, which includes a data TLB unit 1372 coupled to a data cache unit 1374 coupled to a level 2 (L2) cache unit 1376. In one exemplary embodiment, the memory access units 1364 may include a load unit, a store address unit, and a store data unit, each of which is coupled to the data TLB unit 1372 in the memory unit 1370. The instruction cache unit 1334 is further coupled to a level 2 (L2) cache unit 1376 in the memory unit 1370. The L2 cache unit 1376 is coupled to one or more other levels of cache and eventually to a main memory.

By way of example, the exemplary register renaming, out-of-order issue/execution core architecture may implement the pipeline 1300 as follows: 1) the instruction fetch 1338 performs the fetch and length decoding stages 1302 and 1304; 2) the decode unit 1340 performs the decode stage 1306; 3) the rename/allocator unit 1352 performs the allocation stage 1308 and renaming stage 1310; 4) the scheduler unit(s) 1356 performs the schedule stage 1312; 5) the physical register file(s) unit(s) 1358 and the memory unit 1370 perform the register read/memory read stage 1314; the execution cluster 1360 perform the execute stage 1316; 6) the memory unit 1370 and the physical register file(s) unit(s) 1358 perform the write back/memory write stage 1318; 7) various units may be involved in the exception handling stage 1322; and 8) the retirement unit 1354 and the physical register file(s) unit(s) 1358 perform the commit stage 1324.

The core 1390 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 1390 includes logic to support a packed data instruction set extension (e.g., AVX1, AVX2), thereby allowing the operations used by many multimedia applications to be performed using packed data.

Additionally, some exemplary embodiments include, but are not limited to:

### Example 1

A method comprising:

decoding an instruction, the instruction including fields for an opcode, first and a second source operand identifiers, and a destination operand identifier, the opcode to indicate that execution circuitry is to: perform a packed data operation as indicated by the opcode as a scalar and broadcast operation when there is uniformity between packed data elements in both of the identified source operands by performing a single scalar operation using scalar circuitry that is equivalent to the packed data operation using one packed data element of each of the identified source operands to generate a single result and broadcast the single result into each packed data element positions of the identified packed data destination operand; and

in response to the decoded instruction, determining uniformity of each of the identified packed data source operands;

when there is uniformity between packed data elements in both of the identified source operands, performing the single scalar operation using scalar circuitry that is equivalent to the packed data operation using one packed data element of each of the identified source operands to generate the single result and broadcast the single result into each packed data element positions of the identified packed data destination operand.

### Example 2

The method of example 1, wherein the packed data operation is a logical operation.

### Example 3

The method of example 1, wherein the packed data operation is an arithmetic operation.

### Example 4

The method of any of examples 1-3, wherein uniformity is to be determined by at least one of rename circuitry, allocator circuitry, scheduler circuitry, and execution circuitry.

### Example 5

The method of any of examples 1-4, wherein when there is not is not uniformity, performing the packed data logical or arithmetic operation using packed data circuitry.

### Example 6

The method of example 5, wherein the packed data circuitry is logical circuitry.

### Example 7

The method of example 5, wherein the packed data circuitry is arithmetic circuitry.

### Example 8

An apparatus to perform the method of any of examples 1-7.

### Example 9

A non-tangible machine-readable storage medium storing an instruction that is to cause a processor to perform a method according to any of examples 1-7.

### Example 10

A method comprising:

decoding an instruction that includes a field for an opcode, a field to identify a source operand to store a plurality of indexes, one or more fields to generate one or source memory locations, and field for a destination operand identifier, the opcode to indicate that execution circuitry is to perform a packed data gather operation equivalent;

in response to the decoded instruction, determining uniformity of each of the identified source operands;

executing the decoded instruction by performing a packed data gather operation by loading of the data element stored in the identified memory location and broadcasting the loaded data element into all data element positions of the identified packed data destination operand when there is uniformity of the data elements of the identified plurality of indices.

### Example 11

The method of example 10, further comprising:

executing the decoded instruction by performing a packed data load of consecutive data elements stored in memory starting at the identified memory location when the packed data elements of the plurality of indices are not the same, but have values that are consecutive.

### Example 12

The method of example 10, further comprising:

executing the decoded instruction by performing a packed data load and permute of consecutive data elements stored in memory starting at the identified memory location when the packed data elements of the plurality of indices are not the same, but are indicative of clusters.

### Example 13

The method of example 10, further comprising:

executing the decoded instruction by performing a regular vector gather when the plurality of the indices have no uniformity (and, depending on the implementation, are not consecutive or indicative of clusters).

### Example 14

The method of any of examples 10-13, wherein uniformity is to be determined by at least one of rename circuitry, allocator circuitry, scheduler circuitry, and execution circuitry.

### Example 15

An apparatus to perform the method of any of examples 10-14.

### Example 16

A non-tangible machine-readable storage medium storing an instruction that is to cause a processor to perform a method according to any of examples 10-14.

### Example 17

A method comprising:

decoding an instruction having a field for an opcode, a field to identify a source operand to store a plurality of indexes, one or more fields to generate one or destination memory locations, and field for a source operand identifier, the instruction to indicates that execution circuitry is to perform a packed data scatter operation equivalent;

in response to the decoded instruction, determining uniformity of each of the identified source operands;

executing the decoded instruction by performing a store and broadcast of a data element stored in a most-significant data element position of the identified source operand into the identified destination memory location all data element positions of the identified packed data destination operand when there is uniformity of the data elements of the identified plurality of indices.

### Example 18

The method of example 17, further comprising:

executing the decoded instruction by performing a packed data store of data element elements in consecutive data element positions of the identified source operand in consecutive destination memory addresses starting at the identified memory location when the packed data elements of the plurality of indices are not the same, but have values that are consecutive.

### Example 19

The method of example 17, further comprising:

executing the decoded instruction by performing a packed data store and permute of consecutive data elements of the identified source operand into memory starting at the identified destination memory location when the packed data elements of the plurality of indices are not the same, but are indicative of clusters.

### Example 20

The method of example 17, further comprising:

executing the decoded instruction by performing a regular vector scatter when the plurality of the indices have no uniformity.

### Example 21

The method of any of examples 17-20, wherein uniformity is to be determined by at least one of rename circuitry, allocator circuitry, scheduler circuitry, and execution circuitry.

### Example 22

An apparatus to perform the method of any of examples 17-21.

### Example 23

A non-tangible machine-readable storage medium storing an instruction that is to cause a processor to perform a method according to any of examples 17-22.

I claim:

1. A method comprising:
decoding an instruction, the instruction including fields for an opcode, first and a second source operand identifiers, and a destination operand identifier, the opcode to indicate that execution circuitry is to: perform a packed data operation as indicated by the opcode as a scalar and broadcast operation when there is uniformity between packed data elements in both of the identified source operands by performing a single scalar operation using scalar circuitry that is equivalent to the packed data operation using one packed data element of each of the identified source operands to generate a single result and broadcast the single result into each packed data element positions of the identified packed data destination operand; and
in response to the decoded instruction, determining uniformity of each of the identified packed data source operands;
when there is uniformity between packed data elements in both of the identified source operands, performing the single scalar operation using scalar circuitry that is equivalent to the packed data operation using one packed data element of each of the identified source operands to generate the single result and broadcast the single result into each packed data element positions of the identified packed data destination operand.

2. The method of claim 1, wherein the packed data operation is a logical operation.

3. The method of claim 1, wherein the packed data operation is an arithmetic operation.

4. The method of claim 1, wherein uniformity is to be determined by at least one of rename circuitry, allocator circuitry, scheduler circuitry, and execution circuitry.

5. The method of claim 1, wherein when there is not is not uniformity, performing the packed data logical or arithmetic operation using packed data circuitry.

6. The method of claim 5, wherein the packed data circuitry is logical circuitry.

7. The method of claim 5, wherein the packed data circuitry is arithmetic circuitry.

8. An apparatus comprising:
decoder circuitry to decode an instruction, the instruction including fields for an opcode, first and a second source operand identifiers, and a destination operand identifier, the opcode to indicate that execution circuitry is to: perform a packed data operation as indicated by the opcode as a scalar and broadcast operation when there is uniformity between packed data elements in both of the identified source operands by performing a single scalar operation using scalar circuitry that is equivalent to the packed data operation using one packed data element of each of the identified source operands to generate a single result and broadcasting the single result into each packed data element positions of the identified packed data destination operand; and
circuitry to determine uniformity of each of the identified packed data source operands;
execution circuitry to execute the decoded instruction, when there is uniformity between packed data elements in both of the identified source operands, the execution circuitry to performg the single scalar operation using scalar circuitry that is equivalent to the packed data operation using one packed data element of each of the identified source operands to generate the single result and broadcast the single result into each packed data element positions of the identified packed data destination operand.

9. The apparatus of claim 8, wherein the packed data operation is a logical operation.

10. The apparatus of claim 8, wherein the packed data operation is an arithmetic operation.

11. The apparatus of claim 8, wherein uniformity is to be determined by at least one of rename circuitry, allocator circuitry, scheduler circuitry, and execution circuitry.

12. The apparatus of claim 8, wherein when there is not is not uniformity, the execution circuitry is to perform the packed data logical or arithmetic operation using packed data circuitry.

13. The apparatus of claim 12, wherein the packed data circuitry is logical circuitry.

14. The apparatus of claim 12, wherein the packed data circuitry is arithmetic circuitry.

15. A non-tangible machine-readable storage medium storing an instruction that is to cause a processor to perform a method comprising:
decoding an instruction, the instruction including fields for an opcode, first and a second source operand identifiers, and a destination operand identifier, the opcode to indicate that execution circuitry is to: perform a packed data operation as indicated by the opcode as a scalar and broadcast operation when there is uniformity between packed data elements in both of the identified source operands by performing a single scalar operation using scalar circuitry that is equivalent to the packed data operation using one packed data element of each of the identified source operands to generate a single result and broadcast the single result into each packed data element positions of the identified packed data destination operand; and
in response to the decoded instruction, determining uniformity of each of the identified packed data source operands;
when there is uniformity between packed data elements in both of the identified source operands, performing the single scalar operation using scalar circuitry that is equivalent to the packed data operation using one packed data element of each of the identified source operands to generate the single result and broadcast the single result into each packed data element positions of the identified packed data destination operand.

16. The non-tangible machine-readable storage medium of claim 15, wherein the packed data operation is a logical operation.

17. The non-tangible machine-readable storage medium of claim 15, wherein the packed data operation is an arithmetic operation.

18. The non-tangible machine-readable storage medium of claim 15, wherein uniformity is to be determined by at least one of rename circuitry, allocator circuitry, scheduler circuitry, and execution circuitry.

19. The non-tangible machine-readable storage medium of claim 15, wherein when there is not is not uniformity, performing the packed data logical or arithmetic operation using packed data circuitry.

20. The non-tangible machine-readable storage medium of claim 19, wherein the packed data circuitry is logical or arithmetic circuitry.
